(19) United States
(12) Patent Application Publication
(10) Pub. No.: US 2016/0019652 A1
(43) Pub. Date: Jan. 21, 2016

(54) QUASI-NATIVE ANNUITY APPLICATION

(71) Applicant: CMFG Life Insurance Company, Madison, WI (US)

(72) Inventors: Dennis M. Moon, Middleton, WI (US); Brian J. Pook, Cottage Grove, WI (US)

(73) Assignee: CMFG LIFE INSURANCE COMPANY, Madison, WI (US)

(21) Appl. No.: 14/336,145

(22) Filed: Jul. 21, 2014

(51) Int. Cl. G06Q 40/08

(52) U.S. Cl. CPC G06Q 40/08

(57) ABSTRACT

A method of presenting an annuity product comprises receiving, at an application server device, a session initiation request from a user device; authenticating, via an authentication device, a user corresponding to the user device; establishing, by the application server device, a secure session with the user device; pre-loading, by the application server device, one or more interface resources to the user device; and conducting, by the application server device, a quasi-native interaction session with the user device. The quasi-native interaction session includes a quasi-native user interface which presents as a single web page.

### BACKGROUND OF THE INVENTION

1. Field of the Invention

This application relates generally to an electronically-implemented application for presenting annuity data. More specifically, the application relates to a system and method of providing for a quasi-native application for the presentation of a hybrid annuity to a consumer, and the selection thereof by the consumer.

2. Description of Related Art

Annuities are long-term insurance products designed for retirement purposes. Among several different types of annuities, single-premium indexed annuities offer several advantages, such as the opportunity for higher earnings or returns, tax deferral, and the compounding of interest.

However, like most investments, annuity contract values, death benefits, and other values fluctuate based on the performance of the particular investment options which comprise the investment itself. In this manner, annuities retain some risk associated with market factors. This risk may cause potential investors to avoid products such as annuities, especially if the individual investor is nearing planned retirement age.

Attempts to provide particular types of annuities with reduced risk or downside typically result in increased complexity of the underlying annuity product. Attempts by insurers or their agents to educate consumers about the product may therefore require an undesirably large amount of time and effort. Additionally, this complexity may discourage consumers from investing in the product, and may discourage insurers or their agents from pursuing individual or small investors.

Historically, insurers have sought to provide such information as a series of static web pages. However, such traditional web-based methods of information presentation suffer from numerous drawbacks, including undesirable page load times, bandwidth constraints, and degraded or outdated user experiences. Native applications (for example, a software program or smartphone app) suffer from their own disadvantages, including memory and computing power limitations, reduced data security, and difficulty in updating or upgrading the application.

Accordingly, there exists a need for an improved system and method for educating consumers regarding these complex products simply and efficiently, and for presenting information regarding the annuities via a quasi-native application with a minimal footprint on the user device.

### BRIEF SUMMARY OF THE INVENTION

To that end, this disclosure relates to a system and method for presenting information regarding an annuity. Specifically, this disclosure relates to a system and method for providing a quasi-native application to accept user inputs and present associated annuity information to the user and/or an ultimate consumer without requiring specialized software on the user terminal.

In one exemplary aspect of the present disclosure, a method of presenting an annuity product is described. This method comprises receiving, at an application server device, a session initiation request from a user device; authenticating, via an authentication device, a user corresponding to the user device; establishing, by the application server device, a secure session with the user device; pre-loading, by the application server device, one or more interface resources to the user device; and conducting, by the application server device, a quasi-native interaction session with the user device.

In another exemplary aspect of the present disclosure, computing system for presenting an annuity product is described. This system comprises an application server device configured to receive a session initiation request from a user device; and an authentication device configured to authenticate a user corresponding to the user device. The application server device is further configured to establish a secure session with the user device, to pre-load one or more interface resources to the user device, and to conduct a quasi-native interaction session with the user device.

In yet another exemplary aspect of the present disclosure, a non-transitory computer-readable medium is disclosed. The non-transitory computer-readable medium stores computer-executable instructions which, when executed by a processor of a computing device, cause the computing device to perform operations comprising receiving, at an application server device, a session initiation request from a user device; authenticating, via an authentication device, a user corresponding to the user device; establishing, by the application server device, a secure session with the user device; pre-loading, by the application server device, one or more interface resources to the user device; and conducting, by the application server device, a quasi-native interaction session with the user device.

In various ones of the above exemplary aspects of the present disclosure, the application server device may further generate a quasi-native user interface and to receive a user interaction request. This user interaction request may include a request for information regarding an annuity product, a request for information regarding the purchasing of an annuity product, and/or a request for information regarding the modification of an annuity product. Preferably, the quasi-native user interface presents to the user as a single web page to mimic a native application.

Additionally, in various ones of the above exemplary aspects of the present disclosure, the application server device is further configured to calculate annuity information according to a risk rate ruleset.

By the above exemplary aspects, the present disclosure provides for a system and method which improves the underlying operation of the user device in several regards.

This disclosure can be embodied in various forms, including business processes, computer-implemented methods, computer program products, computer systems and networks, user interfaces, application programming interfaces, and the like. The foregoing summary is intended solely to give a general idea of various aspects of the present disclosure, and does not limit the scope of the disclosure in any way.

### DESCRIPTION OF THE DRAWINGS

These and other more detailed and specific features of various embodiments are more fully disclosed in the following description, reference being had to the accompanying drawings, in which:

FIG. 1 is a flowchart illustrating an exemplary process of providing a quasi-native annuity application according to various aspects of the present disclosure.

FIG. 2 is a flowchart illustrating an exemplary subroutine for use with various aspects of the present disclosure.

FIG. 3. is a flowchart illustrating an exemplary process of creating or updating an annuity data structure according to various aspects of the present disclosure.

FIG. 4 is a flowchart illustrating an exemplary subroutine for use with the various aspects of the present disclosure.

FIG. 5 is a flowchart illustrating an exemplary calculation process for use with various aspects of the present disclosure.

FIG. 6 is a block diagram illustrating an exemplary system for providing a quasi-native annuity application according to various aspects of the present disclosure.

FIG. 7 is a block diagram illustrating an exemplary device for providing a quasi-native annuity application according to various aspects of the present disclosure.

FIG. 8 is a schematic diagram illustrating an exemplary interface for providing a quasi-native annuity application according to various aspects of the present disclosure.

### DETAILED DESCRIPTION

In the following description, numerous details are set forth, such as flowcharts, data tables, and system configurations. It will be readily apparent to one skilled in the art that these specific details are merely exemplary and not intended to limit the scope of this application.

Systems and methods are disclosed that provide insurer representatives (for example, licensed insurance agents) with the means to present information regarding annuity products to consumers, to input consumer preferences, and to customize product details. Although discussed herein in the context of annuities, it should be understood that the systems and method disclosed herein are not limited to annuities, but have application with respect to other types of investment products and presentations.

As used below, the term “quasi-native” refers to a session or application which appears to the user to be a native application, while not requiring any specialized software or application on the user device beyond a simple web browser. For example, a quasi-native application may include full-screen operation and appear as a single page comprising smooth transitions and animations. Generally, the quasi-native interaction session requires fewer local resources and/or fewer instances of data transfer than would a corresponding native application having a similar user experience.

Additionally, the term “native” refers to a session or application running on a user device without external support. For example, a native application may be an installed software program that operates mostly or wholly using resources local to the user device.

[User Session]

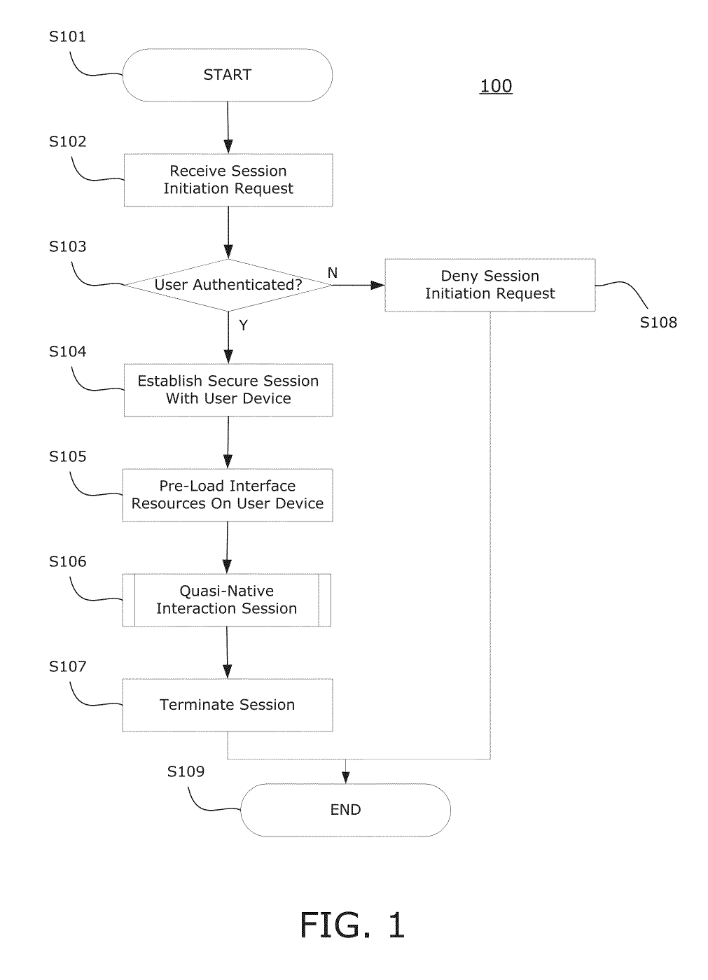

FIG. 1 is an example of a process 100 which comprises a user session. Process 100 takes place on a computing device having a processor and a memory. Process 100 takes place on a central server in response to communications received from a user terminal or device; for example, via a network schematic of the type which will be discussed in more detail below.

In this example, process 100 is initialized at step S101. Process 100 then proceeds to step S102 and receives a session initiation request. The session initiation request may be received from a user, such as an insurer agent, or from an administrator. The session initiation request may be any attempt by a user to access a web address corresponding to a secure page. Upon receipt of the session initiation request, process 100 initiates a user authentication step S103.

User authentication step S103 may include one or more subprocesses of receiving a username/password combination, determining a device identifier (ID), determining a user group, and the like. For security purposes, authentication is performed server-side, such as by a Single Sign-On (SSO) service installed on a web server.

Additionally or alternatively, step S103 may be configured to provide a distinction between different levels of access. For example, step S103 may grant full access where it determines that the user has full permissions (such as where the user is an approved financial advisor), and may grant partial or limited access where it determines that the user has guest permissions (such as where the user is a demo user). Of course, these permissions may be dynamically modified or updated by a system administrator. In any event, where step S103 determines that the user has permission to access at least some secure resources, process 100 proceeds to step S104 and establishes a secure session with the user device.

If, however, step S103 determines that the user does not have permission to access the secure resources, process 100 proceeds to step S108 and denies the session initiation request. Step S108 may include one or more subprocess of issuing an error message to the user, alerting an administrator, and/or redirecting the user to an unsecured or public site. Subsequently, process 100 proceeds to step S109 and terminates.

While exemplary process 100 shows only a single user authentication step S103 for each user session, the application may be modified so as to run a similar authentication step for each action requested by the user device. For example, the server-side code may include a filter configured to authenticate user information once for each page request and store the information for later retrieval in the same session. Additionally or alternatively, the server-side code may include a global filter configured to authenticate user information for each action request, even if the action does not include a page request.

Once the secure session has been established, process 100 proceeds to step S105 and pre-loads various interface resources to the user device. Step S105 operates under an optimization framework to balance the importance of reduced load times with a desire to prevent user devices from caching resources too aggressively. Step S105 may access server-side code in order to perform such operations as optimizing JavaScript (JS) and cascading style sheet (CSS) files, managing the transfer of image files, combining related images into sprites, and the like.

The particular resources which are pre-loaded in step S105 include many CSS or JS file resources which have been minified and concatenated into files, thereby to minimize the number of concurrent downloads to the user device and achieve an improved application load time. Images are similarly optimized to obtain minimum file sizes and combined into sprites to further minimize the number of concurrent downloads to the user device.

Where the user device operates a web browser that supports the use of cache manifest, a Cache Manifest Handler module asynchronously downloads and caches in the browser specific types of file resources (for example, CSS, JS, partial HTML view templates, and the like) to effectively pre-load these files, thereby greatly reducing apparent view transition times for an improved overall user experience.

Where the user device operates a web browser that does not support cache manifest, other caching techniques used in the server device configuration do still cache previously requested file resources to provide some reduction in apparent view transition times during subsequent revisits to a view.

Among the initial resources pre-loaded to the user device are global constants, cap rates, sample index year-end performance rates, surrender charge rates, advisor profile information, report data, and the like. Thus, further calculations may run client-side (that is, on the user device) without requiring additional requests to or from the server for data to perform calculations. This provides the fastest possible user experience.

Once the initial resources have been pre-loaded to the user device, process 100 proceeds to step S106 and conducts various subprocesses comprising a quasi-native interaction session. These subprocesses will be described in more detail below.

In any event, after the quasi-native interaction session has concluded, process 100 proceeds to step S107 and terminates the session. Step S107 may include commands sent to the user device to delete some or all cached files and/or internal commands to release server-side resources. Upon termination of the session, process 100 ends at step S109.

[Quasi-Native Session]

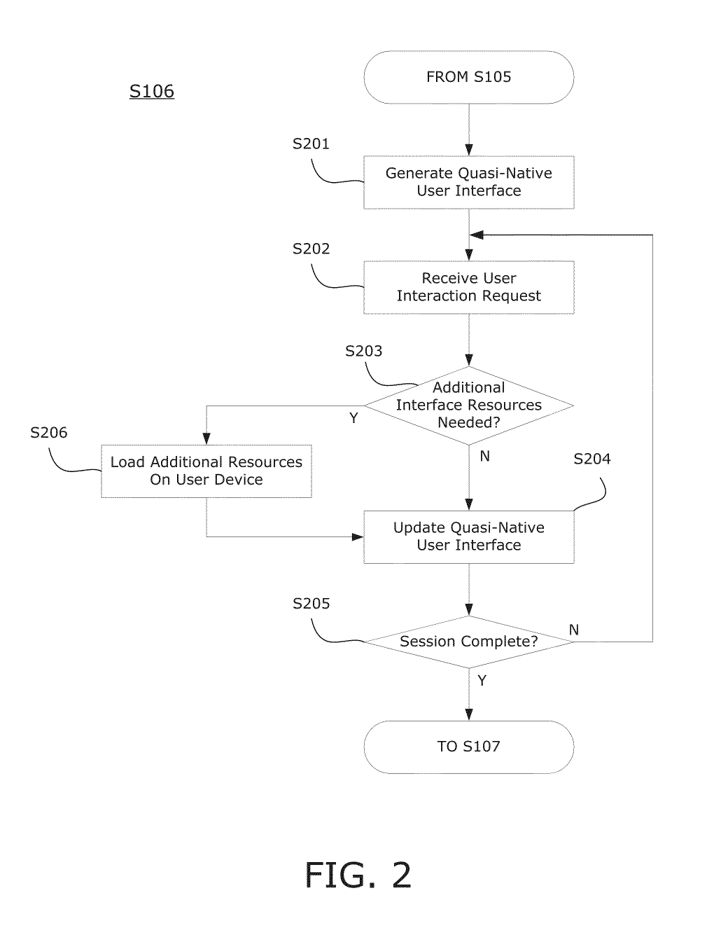

FIG. 2 is an example of various subprocesses comprising the quasi-native interaction session described above with regard to step S106. The quasi-native interaction session begins at step S201, where the server generates a quasi-native user interface. While specific examples of a quasi-native user interface will be given below, the quasi-native user interface generally includes attributes designed to mimic the user environment of a native application.

For example, the quasi-native user interface may be configured to operate in full-screen mode so as to mask unnecessary visual features of the operating system, cursors or mouse pointers, and/or particular web browser used on or by the user device. In any event, the quasi-native user interface contains interactive elements, including input elements configured to receive input from a user and display elements configured to convey information to the user.

After the quasi-native user interface has been generated, delivered to the user device, and displayed on a display associated with the user device, the quasi-native interaction session awaits a user interaction request (that is, a user input) such as a mouse click, a screen tap, a keyboard input, a voice command, and the like. Exemplary user interaction requests include requests to display updated data, requests to change display settings, requests to print or e-mail a report, requests to initiate application paperwork (including electronic paperwork), and the like. This interaction request is received at step S202.

Upon receipt, the quasi-native interaction session first determines whether additional interface resources are needed on the user device at step S203. For many user interaction requests, the necessary interfaces will have been pre-loaded during step S105 described above. In this case, the quasi-native interaction session determines that no additional interface resources are needed and proceeds directly to step S204 to update the quasi-native user interface. Step S204 may comprise operations to generate a new quasi-native user interface in the manner described above with regard to step S201, may comprise operations to generate new sub-interfaces for only a portion of the existing quasi-native user interface, and/or may comprise no operations as needed.

Where step S203 determines that additional interface resources are needed on the user device, the quasi-native interaction session proceeds to step S206 before proceeding to step S204. In step S206, the quasi-native interaction session loads the requisite additional resources to the user device; for example, in a manner similar to that described above with regard to step S105. Step S206 may further comprise operations to load additional resources which are not immediately required, but which the quasi-native interaction session anticipates will be needed for subsequent user interaction requests.

In any event, upon the completion of step S204, the quasi-native interaction session proceeds to step S205 where a determination is made as to whether the session is complete. If the session is deemed to be complete (for example, if a log-out request is received or if the browser is closed), the quasi-native interaction session returns to process 100 and, specifically, step S107 described above.

If, on the other hand, the session is not deemed to be complete (for example, if no termination indicator is received), the quasi-native interaction session returns to step S202 and awaits further user interaction requests.

[Exemplary Hybrid Annuity]

As noted above, exemplary user interaction requests preferably include informational and other requests regarding an annuity. While not intended to be unduly limiting, a preferred example of an annuity product for use with the quasi-native annuity application of the present disclosure is described herein.

The exemplary annuity is a registered indexed annuity designed for accumulation. The annuity is designed such that the purchaser (for example, the consumer described above) receives returns linked to an equity index (for example, the S&P 500 Index), with interest credited on the anniversary of purchase. The exemplary annuity is most preferably a hybrid annuity wherein payments are allocated between two different accounts, each linked to the equity index but having unique risk profiles. In this manner, the hybrid annuity includes a secure account and a growth account.

The secure account is designed to protect the principal from market volatility. Specifically, the secure account has a return rate floor of 0% and a return rate cap which is determined semi-monthly based on market conditions. The particular return rate cap corresponds to the specific cap determination at the time of purchase, and may remain the same for the life of the annuity or may be reevaluated annually on the anniversary of purchase.

The growth account is designed to provide an opportunity for greater market growth compared to the secure account in exchange for some downside risk. Specifically, the growth account has a return rate floor of down to −10% and a higher return rate cap compared to the secure account. The particular return rate cap for the growth account is similarly determined on a semi-monthly basis.

In this manner, the consumer determines his or her preferred “comfort zone” of risk, and the annuity funds are distributed accordingly between the secure account and the growth account. By way of a non-limiting example, suppose that a particular consumer is comfortable risking a potential annual loss (downside) of 5% in exchange for a potential annual gain (upside) of 7%. Assuming for mathematical convenience that the secure account has a rate floor of 0% and a rate cap of 2%, and the growth account has a rate floor of −10% and a rate cap of 12%, annuity purchase funds are distributed 50% to the secure account and 50% to the growth account. If the particular consumer desires a smaller downside (and therefore smaller potential for growth) or a larger upside (and therefore larger risk), the amount allocated to the growth account will be smaller or larger, respectively.

The consumer may also select his or her desired index period; for example, a period of 5, 7, or 10 years. Generally, contracts having longer periods will have higher determined rate caps in exchange for the reduced liquidity. That is, within the index period, withdrawals may be subject to a surrender charge subject to a threshold withdrawal amount.

The registered indexed annuity allows the consumer to change his or her allocation profile at any time; however, changes only take effect on the following purchase anniversary. The index period, on the other hand, preferably remains the same throughout the life of the annuity and cannot be changed. Additional or alternative modifications may include looking up partial-term results in anticipation of adding more funds.

On each purchase anniversary during the index period, interest (whether positive, negative, or zero) is credited to each account and added to or subtracted from the account balance. The entirety of this updated account value is then eligible for interest on the following anniversary, so as to provide the potential for compound interest. The particular calculations involved in determining the applied interest rate and the account balances will be described in more detail below.

[Annuity Data Structure]

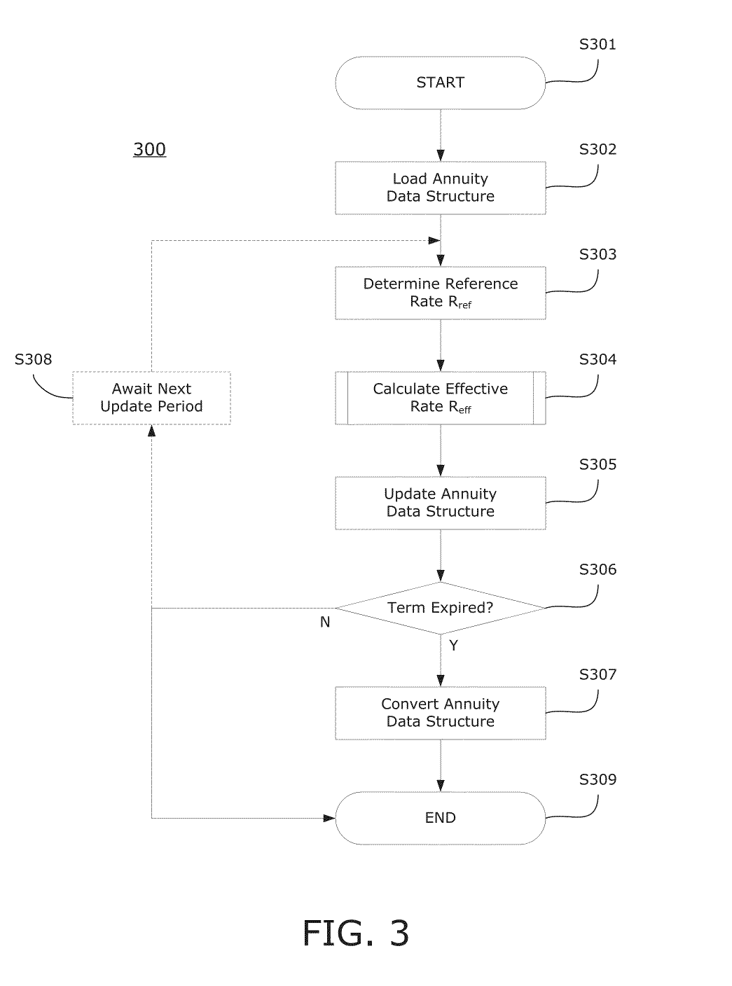

FIG. 3 illustrates an exemplary process 300 for determining the value of an annuity contained in a data structure. Process 300 takes place on a computing device having a processor and a memory. Process 300 may comprise a subprocess of process 100, such as a series of operations in response to the user interaction request of step S202, or may be a standalone process. Most preferably, process 300 takes place on a central server or database so as to provide improved security.

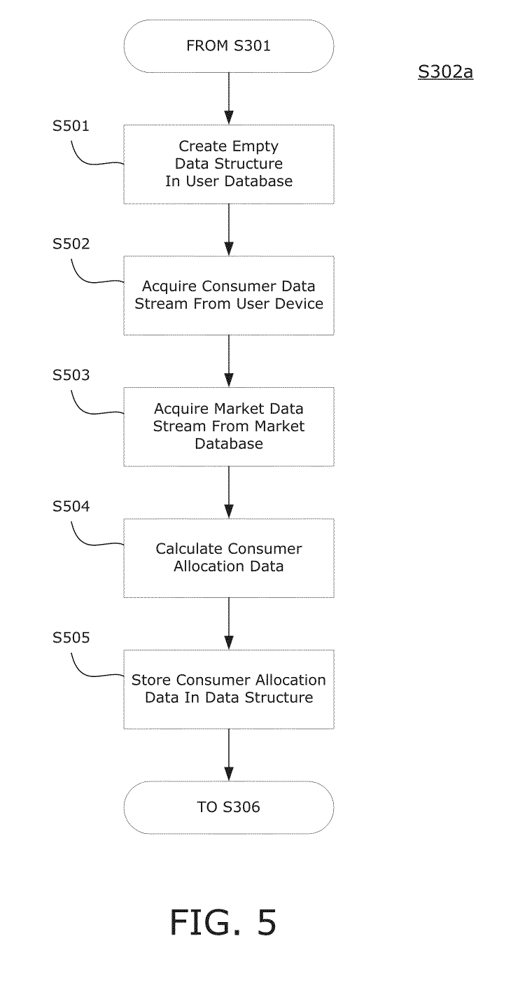

In this example, process 300 is initialized at step S301. Process 300 then proceeds to step S302 and loads an annuity data structure into memory. The current example assumes that an annuity data structure already exists, for example in a database, and therefore may simply be loaded. If, however, no such annuity data structure exists, step S302 is replaced with step S302a as will be described with regard to FIG. 5.

Assuming the annuity data structure already exists and has been loaded in step S302, process 300 proceeds to step S303 and determines a reference rate R_{ref}. Within the context of the exemplary annuity described above, reference rate R_{ref} corresponds to the annualized return of the linked or benchmarked equity index such as the S&P 500 Index. Reference rate R_{ref} is loaded into memory and process 300 proceeds to step S304.

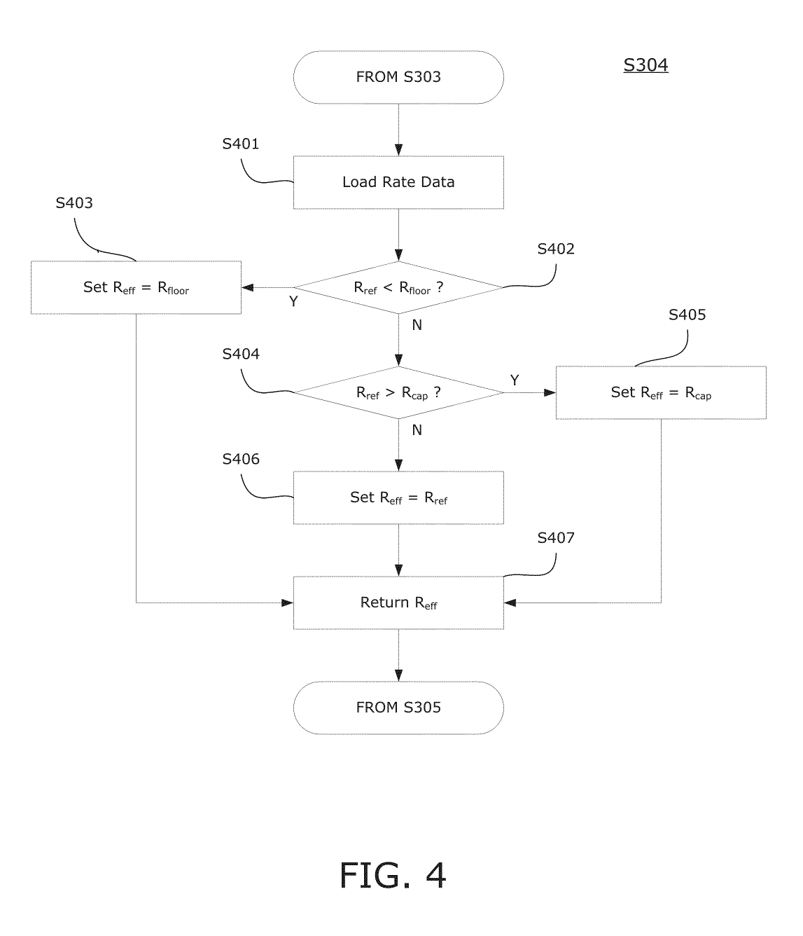

In step S304, the effective rate R_{eff} (that is, the actual rate applied to the account) is calculated. This calculation comprises operations performed by a calculation engine as shown in FIG. 4. One of ordinary skill in the art will readily recognize that the calculations may be performed in series for individual accounts comprising the annuity, may be performed in parallel, or may be performed in a combination of series and parallel. Furthermore, one of ordinary skill in the art will readily recognize that the same functionality may be achieved by applying the calculation operations in a different order from that illustrated in FIG. 5.

Specifically, as a first operation S401 of step S304, various rate data are loaded into memory. The rate data include the rate floor R_{floor} for the particular account and the rate cap R_{cap} for the particular account. Again, because operations may be performed in parallel for multiple accounts or subaccounts, the rate data may include multiple rate floors R_{secure}_{_{—}}_{floor} and R_{growth}_{_{—}}_{floor}, and/or multiple rate caps R_{secure}_{_{—}}_{cap} and R_{growth}_{_{—}}_{cap}. These rate data or loaded into memory along with the reference rate R_{ref} and the calculation engine proceeds to step S402. The various rate floors R_{floor} and rate caps R_{cap}, along with the reference rate R_{ref}, together with the associated calculation steps and index term, constitute a risk ruleset.

At step S402, the particular rate floor R_{floor} is compared to the reference rate R_{ref}. If R_{ref} is less than R_{floor}, the calculation engine proceeds to step S403 and sets the effective rate R_{eff} to be equal to the rate floor R_{floor}. The calculation engine then proceeds directly to step S407. This corresponds to the situation where the benchmark index experiences losses greater than the guaranteed floor, and the consumer is protected from losses which exceed the predetermined threshold loss.

If R_{ref} is greater than R_{floor}, the calculation engine proceeds to step S404 where the rate cap R_{cap} is compared to the reference rate R_{ref}. If R_{ref} is greater than R_{cap}, the calculation engine proceeds to step S405 and sets the effective rate R_{eff} to be equal to the rate cap R_{cap}. The calculation engine then proceeds directly to step S407. This corresponds to the situation where the benchmark index experiences gains greater than the maximum upside of the annuity.

If neither of the above conditions are met, the calculation engine proceeds to step S406 and simply sets the effective rate R_{eff} to be equal to the reference rate R_{ref}. The calculation engine then proceeds to step S407. This corresponds to the situation where the benchmark index provides a return which is within the consumer's preselected upside/downside window or zone.

Regardless of the particular route, once the calculation engine arrives at step S407 it returns the calculated effective rate R_{eff} and proceeds to step S305 of process 300.

In step S305, the loaded annuity data structure is updated. Typically, step S305 simply comprises applying the effective rate R_{eff} to the annuity account balance. However, in situations where the consumer has changed his or her preferred allocation, new rate floors and caps may be updated into the data structure. Additionally or alternatively, if the insurer wishes to adjust the floors and/or caps, these adjustments may similarly be updated into the data structure.

Process 300 then proceeds to step S306 and determines whether the annuity term (i.e., the index period) has expired. If the term has not expired, process 300 preferably proceeds directly to step S309 and terminates. Optionally, process 300 may instead proceed to step S308 and await the next update period before returning to step S303 to begin a new update process.

If the term has expired, however, process 300 proceeds to step S307 and converts the annuity data structure into a post-term structure. Specifically, after the index period, all contract value is automatically allocated to the secure account, and the growth account is no longer available. By default, index returns on the post-term secure account structure will continue to be credited on the purchase anniversary in the manner described above. At any time after the end of the index period, the consumer may choose to continue the contract, purchase a new contract, covert the contract value, receive the funds as a lump sum, and the like.

As noted, the above analysis requires an existing data structure. If no data structure exists for the annuity account, steps S302-S305 are replaced with step S302a, described in FIG. 5. This step similarly takes place on a computing device having a processor and a memory.

In a first operation of the data structure creation process of step S302a, control passes to step S401 wherein an empty data structure is created in a user database, such as the database of the type described above.

Thereafter, the process proceeds to step S402 and acquires a consumer data stream from a user device, such as the user device described above. This consumer data stream may comprise data packets corresponding to a preferred rate floor, a preferred rate cap, and a preferred index period. The consumer data stream may also comprise data packets corresponding to identifying information regarding the consumer, such as age or other demographic information.

Next, at step S403, the process acquires a market data stream from a market database. The market data stream may comprise data packets corresponding to the determined rate caps of the secure account and growth account, respectively. Data packets contained in the above data stream are loaded into memory.

Based on the various data, the subprocess at step S404 then calculations consumer allocation data. Specifically, based on the respective rate caps and floors of the growth and secure accounts, as well as the current market data, step S404 calculates the particular percentage of the contract value to be invested in the growth account and the secure account, respectively, to achieve the consumer-desired parameters.

Subsequently, the subprocess proceeds to step S405. In this step, the calculated consumer allocation data is stored in the data structure which previously had been created at step S401. Step S405 may further include creating and storing the actual annuity contract values in the data structure. Thereafter, the subprocess ends and process 300 resumes at step S306, described above.

[Network Configuration]

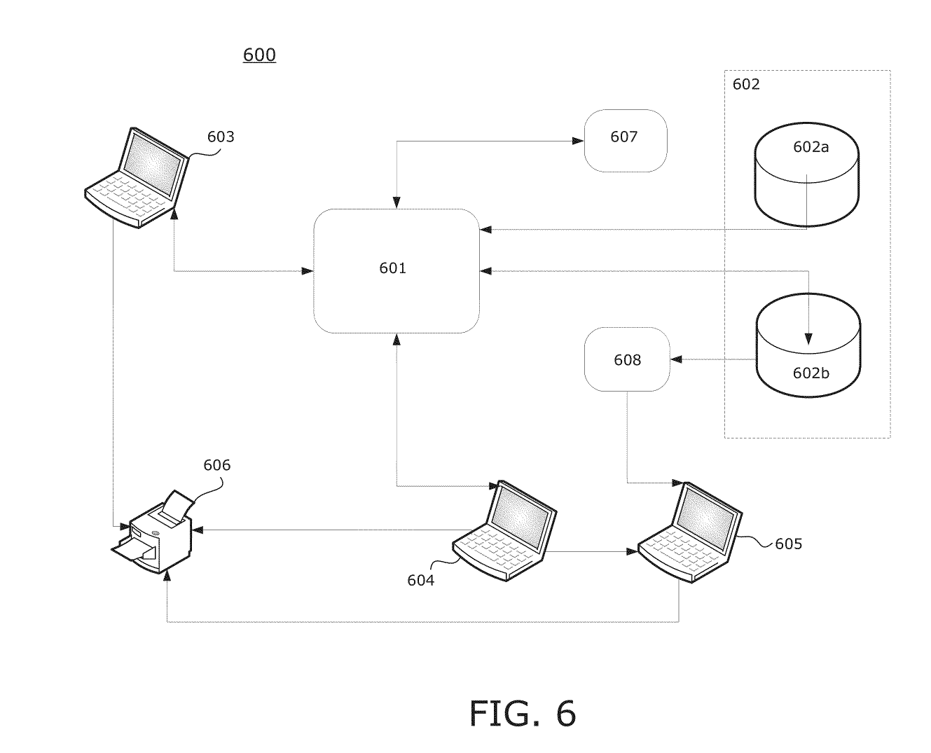

The above processes and subprocesses are necessarily implemented using specialized computing hardware and software and require a unique network structure to effectively operate. An exemplary network 600 is shown in FIG. 6.

In general, a network may be a collection of computers and/or other hardware to provide infrastructure to establish virtual or physical connections and carry communications. For instance, a network may be an infrastructure that generally includes edge, distribution, and core devices and enables a path for the exchange of information between different devices and systems. Furthermore, a network may utilize any conventional networking technology and may, in general, be a packet network (e.g., any of a cellular network, global area network, wireless local area network, wide area network, local area network, or combinations thereof) that provides the protocol infrastructure to carry communications. Network is merely representative, and thus while a single icon illustrates application server 601 and the like, respectively, these illustrations may represent a single network, a combination of different network components and technologies, and/or a plurality of networks as described above.

Exemplary network 600 includes, but is not strictly limited to, an application server 601, a database server 602 including a market database 602a and an annuity database 602b, an administrator terminal 603, a user terminal 604, a consumer terminal 605, an output device 606, a directory server 607, and a report server 608. Respective servers and terminals are also described below as “computing devices.”

One of ordinary skill in the art will recognize that various modifications to the above structure may be made without altering the fundamentally inventive concept of the present disclosure. For example, market database 602a and annuity database 602b may be combined into a single database. Similarly, directory server 607 and report server 608 may be combined into a single server and/or one or more of directory server 607 and report server 608 may be combined into application server 601. Likewise, administrator terminal 603, user terminal 604, and consumer terminal 605 may comprise distinct devices, or one or more of the above terminals may be combined into a single device having different profiles. Although the illustrated example shows a particular number of servers and terminals, the network may comprise more or fewer servers and/or terminals as desired.

The various computing devices described above may be any computing system and/or device that includes a processor and a memory. In general, computing systems and/or devices may employ any of a number of computer operating systems, including, but by no means limited to, versions and/or varieties of the Microsoft Windows® operating system; the Unix operating system (e.g., the Solaris® operating system distributed by Oracle Corporation of Redwood Shores, Calif.); the AIX UNIX operating system distributed by International Business Machines of Armonk, N.Y.; the Linux operating system; the Mac OS X and iOS operating systems distributed by Apple Inc. of Cupertino, Calif.; the BlackBerry OS distributed by Research In Motion of Waterloo, Canada; and the Android operating system developed by the Open Handset Alliance. Examples of computing devices include, without limitation, a computer workstation, a server, a desktop, notebook, laptop, or handheld computer, a cellular phone, a smartphone, a personal digital assistant (PDA), a tablet computer, an e-reader, a smart-TV, a gaming system, a multimedia device, or any other computing system and/or device.

A processor included in such a device may include processes comprised from any hardware, software, or combination of hardware or software that carries out instructions of a computer program by performing logical and arithmetical calculations, such as adding or subtracting two or more numbers, comparing numbers, or jumping to a different part of the instructions. For example, the processor may be any one of, but not limited to single, dual, triple, or quad core processors (on one single chip), graphics processing units, visual processing units, and virtual processors.

It is understood that as used herein, a processor may “perform” or “execute” a particular function by issuing the appropriate commands to other units, such as other components of the computing device, peripheral devices linked to the computing device, or other computing devices. As such, the commands may cause other units to take certain actions related to the function. For example, although a processor does not display an image in the sense of the processor itself physically emitting light in a pattern, the processor may nonetheless “execute” the function of “displaying” an image by issuing the appropriate commands to a display device that would then emit light in the requisite pattern. In this example, the display device that the processor causes to display the image may be part of the computing device that includes the processor, or may be connected remotely to the computing device that includes the processor by way of, for example, a network. In this manner, a processor included in a server hosting a webpage may “display” an image by issuing commands via the Internet to a remote computing device, the commands being such as would cause the remote computing device to display the image. Moreover, for the processor to have “executed” the particular function, the generation of a command that would cause another unit to perform the various actions of the function is sufficient, whether or not the other unit actually completes the actions.

A memory included in such a device may be, in general, any computer-readable medium (also referred to as a processor-readable medium) that may include any non-transitory (e.g., tangible) medium that participates in providing data (e.g., instructions) that may be read by a computer. Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including radio waves, metal wire, fiber optics, and the like, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Computing devices and/or systems may further include a display, support interfaces, and/or communicate within the exemplary network 600. A display is an output device for presentation of information in visual or tactile form, such as interfaces or web portals. Examples of display may include, without limitation, cathode ray tube display, light-emitting diode display, electroluminescent display, electronic paper, plasma display panel, liquid crystal display, high-performance addressing display, thin-film transistor display, organic light-emitting diode display, surface-conduction electron-emitter display, laser TV, carbon nanotubes, quantum dot display, interferometric modulator display, and the like. Thus, a display of any device may generate and/or present interfaces or a web portal to a user, such that the user may interact with and receive information from other computing devices.

Such computing devices and/or systems generally include computer-executable instructions, where the instruction may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, JS, Perl, etc.

The operations described above may be stored entirely in a memory of one of the computing devices comprising the network; for example, the server computing device comprising application server 601. In such a configuration, the operations may be accessed by terminal computing devices via the network connection. Thereby, the terminal computing devices may execute the operations by accessing the program code stored on the server computing device.

Alternatively, the operations may be stored in a distributed manner across more than one computing device. In such a configuration, portions of the operations may be accessed by terminal computing devices via a network connection and other portions of the operations may be accessed by terminal computing devices from their respective internal memories. Thereby, a user may execute a user interface portion of the operations via a terminal computing device, causing the terminal computing device to communicate with the server computing device. In response, the server computing device may execute appropriate portions of the operations and communicate data generated therein to the terminal computing device for storage, display, or further analysis. In an alternate configuration, respective portions of the operations may be performed by a plurality of computing devices in a distributed manner, for example by distributed parallel computing. As noted above, the application server 601 preferably pre-loads various resources to the user device 604 during a quasi-native interaction session.

Databases, data repositories, data tables, or other data stores described herein may include various kinds of mechanisms for storing, accessing, and retrieving various kinds of data, including a hierarchical database, a set of files in a system, an application database in a proprietary format, a relational database management system (RDBMS), etc., or combinations thereof. Each such data store is typically included within a computing device employing a computer operating system such as those mentioned above, and are accessed via a network in a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

The various communication pathways shown in network 600 may comprise a private network such as a local area network (LAN), a wireless local area network (WLAN), a wide area network (WAN), a packet network such as a cellular network, the Internet, or a combination of different types of networks. The communication links therein and therebetween may utilize any antenna technology, such as cellular, Wi-Fi, near field communication (NFC), Bluetooth®, or the like, which is used to exchange data wirelessly using electromagnetic waves. Alternatively or in combination therewith, individual communication links may utilize wired connections, such as metal wires, fiber optics, and the like. As such, individual computing devices may further include, without limitation, networking hardware such as gateways, routers, network bridges, switches, hubs, repeaters, multilayer switches, protocol converters, proxy servers, firewalls, network address translators, multiplexers/demultiplexers, network interface controllers, modems, ISDN terminal adaptors, line drivers, networking cables, input/output ports, and the like.

In the exemplary network 600, individual elements are connected as follows. Application server 601 is configured to retrieve data from market database 602a and annuity database 602b, and to store data in annuity database 602b. Application server 601 is further configured to communicate application and user information with administrator terminal 603. Application server 601 is further still configured to receive inputs from advisor terminal 604 and to send results (including reports) thereto. Application server 601 is yet further configured to send and receive access inquiries and confirmations to and from directory server 607, including authentication information.

Annuity database 602b is further configured to retrieve data from report server 608, and report server 608 is configured to communicate report data to consumer terminal 605. Administrator terminal 603, user terminal 604, and consumer terminal 605 are each respectively configured to send report data to an output device 606, such as a printer. Note that, although exemplary network 600 shows a single output device 606, each individual terminal or group of terminals may be connected to a different output device 606, such as a local printer.

[Server Device]

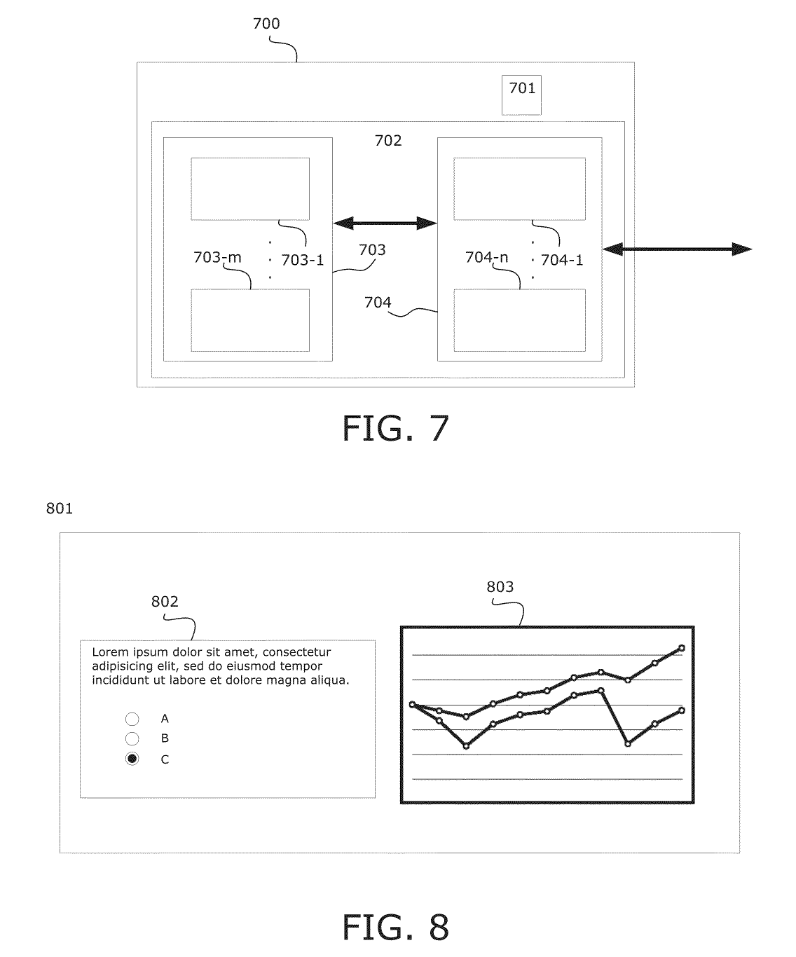

One example of an application server 601 is illustrated in FIG. 7 as application device 700. Application device 700 includes a processor 701, such as a processor of the type described above; and a memory 702, such as a memory of the type described above.

Memory 702 contains a plurality of modules 703 and 704 which may communicate with one another. Various modules are respectively configured with the appropriate instructions to perform tasks as will be described in more detail below. As illustrated, application device 700 contains modules divided into internal-facing modules and external-facing modules. In this manner, modules which perform secure or confidential tasks may be shielded from direct external communication. Here, application device 700 contains m internal-facing modules 703-1 to 703-m, and n external-facing modules 704-1 to 704-n. Although one particular modular breakdown of application device 700 is illustrated, one of ordinary skill in the art will recognize that the same functionality may be provided using fewer, greater, or differently named modules. For example, any two or more of the modules may be integrated with one another into a single module.

Individual modules may manage the dispatch and receipt of data/information along with other applications and/or drivers, as necessary per operating system. A driver may be a computer routine that controls a particular physical component of a device or a peripheral (e.g., a printer, display, input device, or the like) attached to the device. Thus, an individual module may manage and translate input/output requests into data processing instructions for the central processing unit (e.g., processor) and may include a set of executable instructions that itemizes and implements the data structure, object classes, and variables that interact with the drivers to operate physical components and that launch routines and/or programs (e.g., send and receive instructions, data, and/or information to and from individual modules, applications, and/or devices).

Particular modules may include one or more modules selected from the following: communications modules configured to provide data stream exchange between various modules and devices; authentication modules configured to perform the above authentication processes and subprocesses; optimization modules configured to streamline and/or optimize the above data transfer processes; graphics modules configured to generate graphics and other data streams for a user interface; calculation modules configured to perform the above calculations and determinations; management modules configured to manage memory operations; scheduling modules configured to organize and schedule tasks; and the like.

Furthermore, while FIG. 7 illustrates an example wherein all modules are present within a single device, individual modules may be distributed across multiple devices. For example, optimization, calculation, and management modules may be present in a first device such as application server 601, while authentication modules may be present on a second device such as authentication server 607. Indeed, some modules may be distributed to the terminals rather than the servers; for example, graphics modules may be present in user terminal 604. In this manner, cloud computation or increased data security may be achieved.

[Exemplary Interface]

FIG. 8 illustrates an exemplary user interface 801 which may be displayed on a display associated with, for example, user terminal 604. User interface 801 is preferably a quasi-native interface, such as a web page or series of web pages which present to the user as a native application.

User interface 801 illustrates an example wherein a single interface contains both a data input section 802 and a data output section 803. An inventive interface may likewise display more than one input section and/or more than one data output section. Similarly, an inventive interface may not display any input sections or output sections, and therefore may display only output sections or only input sections, respectively.

Input section 802 contains various data fields by which a user may enter information. For example, the user may enter a preferred floor rate, a preferred cap rate, and/or a preferred index period. To facilitate data input, input section 802 may contain associated text, graphics, and/or input forms. Exemplary input forms include radio buttons, checkboxes, pull-down menus, text boxes, sliders, selectable icons, and the like.

Output section 803 contains various fields by which a user may receive information. For example, corresponding to various information entered by the user in input section 802, output section 803 may display a graph detailing predicted returns, etc. Output section 803 may present data by way of graphs such as bar graphs, line graphs, heat maps, and the like, or by way of charts, tables, text, still images, audio, animations, and the like. Output section 803 may further include one or more visualization options to allow the user to control which portions of data should be output.

To maintain the quasi-native nature of the application, interface 801 may provide for smooth transitions between individual screens; for example, when a user inputs information into input section 802, interface 801 may generate a smoothly-animated change to output section 803 within a single web page. Additionally or alternatively, these transitions may include moving various sections and elements around within the screen, creating new elements, and/or removing existing elements.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of presenting an investment product comprising:
receiving, at an application server device, a session initiation request from a user device;
authenticating, via an authentication device, a user corresponding to the user device;
establishing, by the application server device, a secure session with the user device;
pre-loading, by the application server device, one or more interface resources to the user device; and
conducting, by the application server device, a quasi-native interaction session with the user device.

2. The method according to claim 1, wherein the step of conducting a quasi-native interaction section further includes:
generating, by the application server device, a quasi-native user interface; and
receiving, by the application server device, a user interaction request from the user device.

3. The method according to claim 2, wherein the user interaction request includes a request for information regarding an annuity product.

4. The method according to claim 2, wherein the user interaction request includes a request for information regarding purchasing an annuity product.

5. The method according to claim 2, wherein the user interaction request includes a request for information regarding modifying an annuity product.

6. The method according to claim 2, wherein the quasi-native user interface presents as a single web page.

7. The method according to claim 1, wherein the step of conducting a quasi-native interaction session includes calculating, by the application server device, annuity information according to a risk rate ruleset.

8. A computing system for presenting an investment product comprising:
an application server device configured to receive a session initiation request from a user device; and
an authentication device configured to authenticate a user corresponding to the user device;
wherein the application server device is further configured to establish a secure session with the user device, to pre-load one or more interface resources to the user device, and to conduct a quasi-native interaction session with the user device.

9. The computing system according to claim 8, wherein the application server device is further configured to generate a quasi-native user interface and to receive a user interaction request.

10. The computing system according to claim 9, wherein the user interaction request includes a request for information regarding an annuity product.

11. The computing system according to claim 9, wherein the user interaction request includes a request for information regarding purchasing an annuity product.

12. The computing system according to claim 9, wherein the user interaction request includes a request for information regarding modifying an annuity product.

13. The computing system according to claim 9, wherein the quasi-native user interface presents as a single web page.

14. The computing system according to claim 8, wherein the application server device is further configured to calculate annuity information according to a risk rate ruleset.

15. A non-transitory computer-readable medium storing computer-executable instructions which, when executed by a processor of a computing device, cause the computing device to perform operations comprising:
receiving, at an application server device, a session initiation request from a user device;
authenticating, via an authentication device, a user corresponding to the user device;
establishing, by the application server device, a secure session with the user device;
pre-loading, by the application server device, one or more interface resources to the user device; and
conducting, by the application server device, a quasi-native interaction session with the user device.

16. The non-transitory computer-readable medium according to claim 15, wherein the operation of conducting a quasi-native interaction section further includes:
generating, by the application server device, a quasi-native user interface; and
receiving, by the application server device, a user interaction request from the user device.

17. The non-transitory computer-readable medium according to claim 16, wherein the user interaction request includes a request for information regarding an annuity product.

18. The non-transitory computer-readable medium according to claim 16, wherein the user interaction request includes a request for information regarding purchasing an annuity product.

19. The non-transitory computer-readable medium according to claim 16, wherein the quasi-native user interface presents as a single web page.

20. The non-transitory computer-readable medium according to claim 15, wherein the operation of conducting a quasi-native interaction session includes calculating, by the application server device, annuity information according to a risk rate ruleset.
